(19) United States
(12) Patent Application Publication
(10) Pub. No.: US 2011/0232926 A1
(43) Pub. Date: Sep. 29, 2011

(54) FIRE FIGHTING BUCKET FOR AIRCRAFT

(76) Inventors: Donald B. Arney, Salt Spring Island (CA); Earl D. Trautman, Delta (CA)

(21) Appl. No.: 13/031,467

(22) Filed: Feb. 21, 2011

Related U.S. Application Data
(60) Provisional application No. 61/306,144, filed on Feb. 19, 2010.

(51) Int. Cl. A62C 31/28

(52) U.S. Cl. 169/53

(57) ABSTRACT

A collapsible fire fighting bucket for being suspended from a helicopter having an open bucket body of pliable material with an open rim and an opening in the bottom, an annular base member of pliable material that is attached to the bottom adjacent to the opening, a tubular extension (i.e. dump valve) made of pliable material and having a base portion at one end and a free end at the other end with a discharge port, and a heavy duty watertight zipper releasably connecting the base portion of the tubular extension to the annular base member on the bucket body. The zipper enables the dump valve to be easily removed from, and reattached to, the bucket thereby providing an efficient mechanism for replacing a worn out dump valves.

### BACKGROUND OF THE INVENTION

1. Field of the Invention

The invention relates to a collapsible fire fighting bucket for being suspended from a helicopter for fighting forest fires, and in particular to a fire fighting bucket having a removable flexible dump valve.

2. Description of Related Art

Collapsible fire fighting buckets carried by helicopters have become standard equipment for fighting wild fires, and examples of such fire buckets are found in U.S. Pat. Nos. 4,474,245 and 4,576,287 to Donald B. Arney, and U.S. Pat. No. 5,560,429 to Robert D. Needham, all of which are incorporated herein for reference. With reference to FIG. 1, these patents generally disclose fire fighting buckets 1 made of pliable waterproof fabric material having an open upper end with a rim 2 to facilitate filling of the bucket from an open body of water, a side wall 3 extending downwardly from the rim, and a bottom 4 cooperating with the side wall and having an opening. The buckets typically include a harness (not illustrated) for suspending the bucket from a helicopter, the harness typically comprising a control head, which also serves as a connector for connecting to the helicopter, and a plurality of support cables connected to the control head. The harness also includes a plurality of support cables or flexible fabric straps disposed in a zig-zag fashion around and extending upwardly from the upper rim 2 to connect with the plurality of cables. The harness thereby provides an example of a suspension means that enables the bucket to be suspended from the helicopter. Other examples of suspension means may be found in the prior art. A frame assembly 9 is typically provided in cooperation with the rim 2 to provide structure to the rim portion of the bucket. A tubular extension 5 made of pliable material extends from an opening in the bottom of the bucket to a free end formed with a discharge port 6, thus the tubular extension functions as a dump valve. The base of the tubular extension, which is adjacent the opening in the bottom of the bucket, is fastened to the bottom by a plurality of fasteners, typically nut, bolt and washer combinations, that pass through holes in the bottom and the base that are in alignment. Accordingly, the tubular extension is removably attached to the bucket so that it may be replaced when worn.

The discharge port 6 of the tubular extension has an array of grommetted openings 7 extending there around to receive a plurality of cords that are connected to the control head in a manner such that actuation of the control head from the helicopter enables the tubular extension can be drawn upwardly into the bucket by the cords before the bucket is filled with water. The discharge port has a circumferential sealing lip 8 made of soft and resilient material, which forms opposing lip portions which are brought into sealing engagement with each other to minimize water leakage from the tubular extension when the dump valve is positioned below the water surface in the bucket. The plurality of cords serve as purse lines and pass through the grommetted openings to draw the sealing lips into engagement with each other when the cords are tightened. Tension in the cords supports the tubular extension, and the tubular extension is drawn upwardly through the bucket to be supported in a position which can be below an upper level of water within the bucket. Weight of water acting on the tubular extension tensions the cords further and ambient pressure of water acting on the sealing lips augments initial sealing generated by tension in the cords.

To dump the water from the bucket, the control head is actuated so that it rapidly loosens the purse lines by a release or trip mechanism, which permits the tubular extension to fall through the opening in the bottom of the bucket, thereby opening the dump valve. The lip portions are opened essentially simultaneously under the weight of water, permitting rapid discharge of water. Accordingly, the purse lines are an example of control means on the tubular extension adjacent the discharge port by which movement of the tubular extension may be controlled from the helicopter. Other examples of control means may be found in the prior art.

The prior art buckets have been very reliable and, in general, require little maintenance. However, one area of wear relates to the sealing lip portions. It has been found that the relatively soft sealing material of the sealing lips wear after many deployments of the valve due to abrasion, and the wear results in loss of sealing effectiveness with a corresponding leakage of water through the dump valve. Another area of wear is the body of the tubular extension which may develop tears over time. With the prior art buckets, the remedy to worn out tubular extensions is to replace the entire tubular extension, which is time and labour intensive as it requires removal and then replacement of the many fasteners (i.e. nuts, washers and bolts) that connect the base of the tubular extension (i.e. dump valve) to the bucket body. Accordingly, what is needed in fire fighting buckets that rely on flexible tubular extensions to serve as a dump valve is a more efficient method and mechanism for replacing the tubular extensions when they become worn out from use.

### SUMMARY OF THE INVENTION

In order to address some of the shortcomings in the prior art, the present invention provides fire fighting buckets having a tubular extension with a valve body portion that is connected to the bucket via a watertight zipper, thereby facilitating efficient removal and replacement of the valve body portion without having to undo the plurality of fasteners that connect the tubular extension to the bucket.

In some aspects, the present invention provides A collapsible fire fighting bucket for being suspended from a helicopter, the fire fighting bucket comprising an open bucket body of pliable material having an open upper rim to facilitate filling from a body of water, a side wall extending downwardly from the rim and a bottom cooperating with the side wall and having an opening; an annular base member of pliable material that is attached to the bottom adjacent to the opening; a tubular extension made of pliable material and having a base portion at one end and a free end at the other end, wherein the free end defines a discharge port such that the tubular extension functions as a dump valve, the discharge port being sealable for reducing water leakage from the tubular extension; a heavy duty watertight zipper releasably connecting the base portion of the tubular extension to the annular base member on the bucket body; suspension means that enables the bucket to be suspended from the helicopter; and control means on the tubular extension adjacent the discharge port by which movement of the tubular extension may be controlled from the helicopter in a manner that enables the tubular extension to be held in a raised position in which the free end thereof extends upwardly from the bottom with the discharge port positioned below a full water level in the bucket, and to be released and allowed to extend downwardly from the bottom of the bucket for dumping the water.

In some embodiments, the heavy duty watertight zipper is of the kind produced or distributed in 2010 under the trademark RIRI EXTREME by Riri SA of Switzerland/or its affiliates. In some embodiments, the heavy duty watertight zipper is capable of withstanding a force of at least 15 pounds per lineal inch without resulting in separation between the two halves of the zipper. In some embodiments, the heavy duty watertight zipper is capable of withstanding a force of at least 20 pounds per lineal inch without resulting in separation between the two halves of the zipper. In some embodiments, the heavy duty watertight zipper is capable of withstanding a force of at least 45 pounds per lineal inch without resulting in separation between the two halves of the zipper. In some embodiments, the heavy duty watertight zipper is capable of withstanding a force of at least 3.2 pounds per lineal inch for every 1 foot of head height of water capacity of the bucket and 1 foot of zipper diameter defined by the zipper on the annular member.

### BRIEF DESCRIPTION OF THE DRAWINGS

FIG. 1 is a perspective view of a collapsible fire fighting bucket for being suspended from a helicopter;

FIG. 2 is a side view of a fire fighting bucket in accordance with an embodiment of the present invention shown with a portion of a protective zipper flap in cutaway to reveal a heavy duty watertight zipper underneath;

FIG. 3 is a cross section from the side of a fire fighting bucket of FIG. 2 showing the tubular extension drawn into the fire fighting bucket;

FIG. 4 is a magnified view of portion A of FIG. 3, showing the connection between the bucket and the tubular extension, and the watertight zipper;

FIG. 5 is a magnified schematic cross section of a lower portion of the fire fighting bucket in FIG. 2; and

FIG. 6 is a magnified view of portion B of FIG. 5.

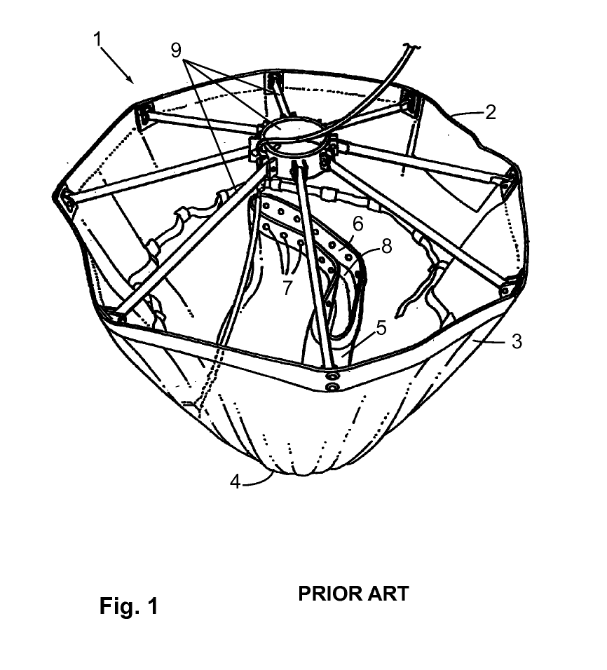

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

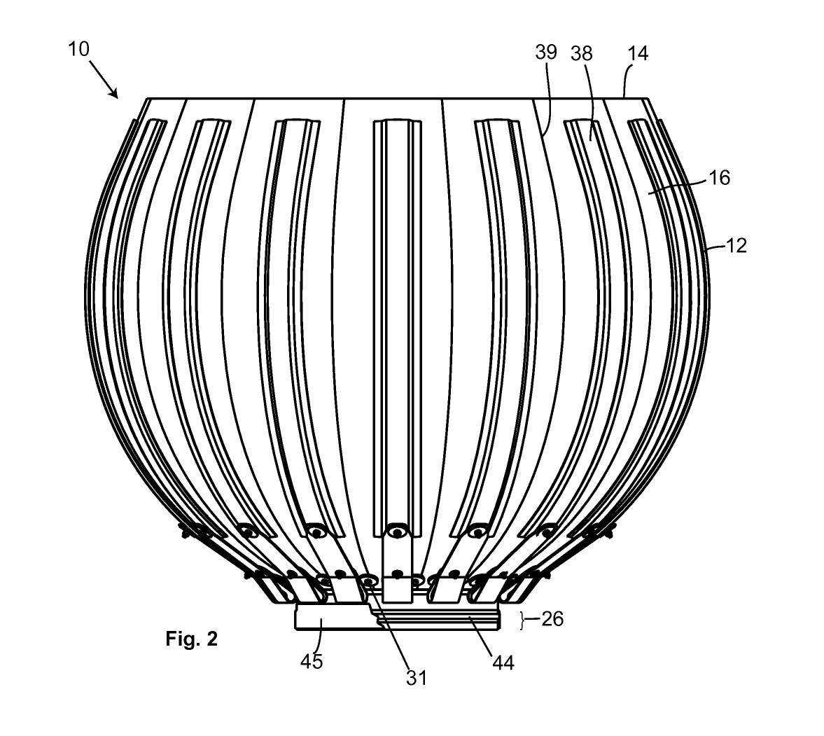

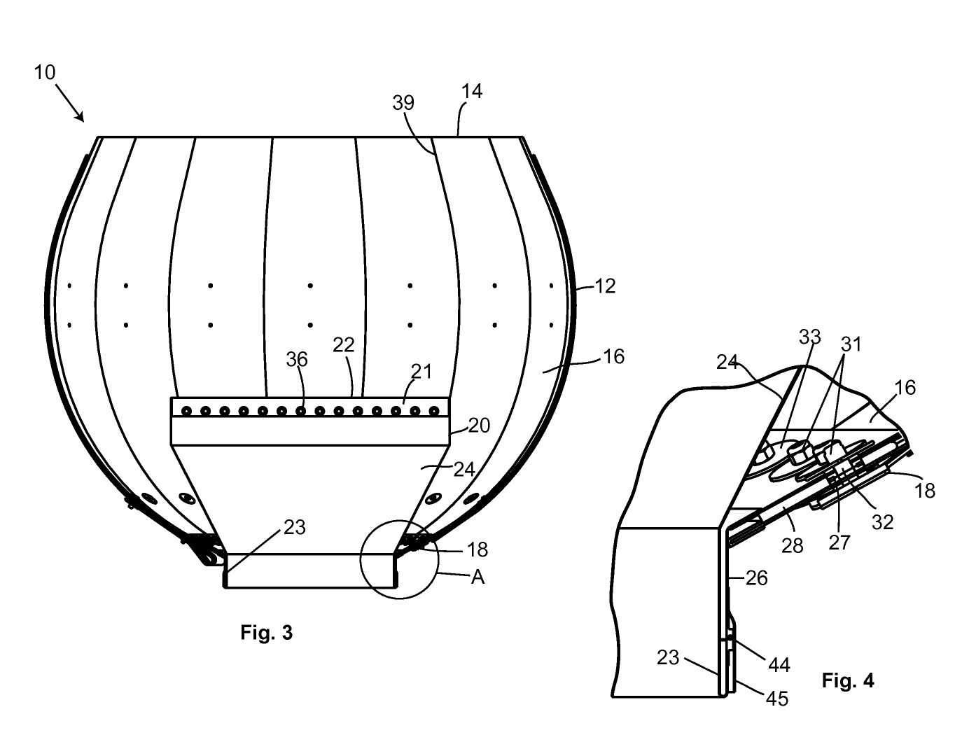

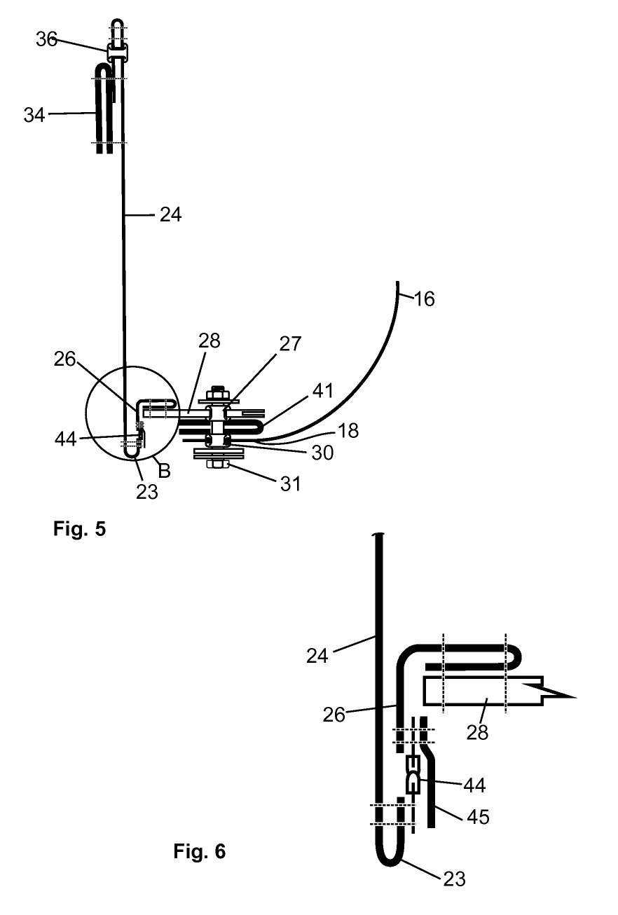

A fire fighting bucket 10 according to the invention bears many similarities to the earlier fire fighting buckets as disclosed in the aforementioned U.S. Pat. Nos. 4,474,245, 4,576,237, and 5,560,429, the disclosures of which are incorporated herein by reference. A brief description of some prior art aspects of the bucket follows, and additional details can be found from the above references. The bucket 10 has an open bucket body 12 made of a tough pliable material, such as for example a vinyl impregnated woven synthetic fabric, and has an open upper rim 14 to facilitate filling of the bucket 10 from an open body of water, for example by dipping into the water. The bucket 10 may be provided with a harness (not illustrated) for suspending the bucket from a helicopter, the harness may include a control head that also serves as a connector for connecting to the helicopter, and a plurality of support cables connected to the control head. The harness may also include a plurality of support cables or flexible fabric straps disposed in a zig-zag fashion around and extending upwardly from the upper rim 14 to connect with the plurality of cables. The harness thereby provides an example of a suspension means that enables the bucket to be suspended from the helicopter. Other examples of suspension means may be found in the prior art. The bucket body 12 has a side wall (also referred to as a shell) 16 extending downwardly from the rim, and a bottom 18 cooperating with the side wall and defining an opening. A tubular extension 20 made of pliable material is shown (FIGS. 2 and 3) in a retracted position extending upwardly into the bucket from the opening in the bottom, and has a base portion 23, a free end portion 21 formed with a discharge port 22 to serve as a dump valve, a valve body 24, and a sealing lip 34. Typically, the various parts are sewn or heat sealed together, and some of the seams are shown in FIGS. 5 and 6 as dotted lines. A plurality of grommetted holes 36 are provided around the perimeter of the free end portion 21 for receiving a plurality of cords or purse lines that are connected to the control head in a manner such that actuation of the control head from the helicopter enables the tubular extension 20 to be drawn upwardly into the bucket by the purse lines before the bucket is filled with water, or lowered by rapidly loosening the purse lines by a release or trip mechanism to permit the tubular extension 20 to fall through the opening in the bottom 18 of the bucket, thereby opening the dump valve. Accordingly, the purse lines are an example of control means on the tubular extension adjacent the discharge port by which movement of the tubular extension may be controlled from the helicopter. Other examples of control means may be found in the prior art. These features are illustrated in the aforementioned U.S. patents and are not shown herein. The bucket side wall 16 includes a plurality of batten pockets 38 extending longitudinally between the rim 14 and the bottom 18 for carrying stiffening battens that provide a degree of rigidity to the bucket 10. Longitudinal fold lines 39 are shown in the side wall that facilitate the folding of the bucket for storage.

An annular base member 26 of pliable material is provided which terminates in an annular flange 28 having a plurality of mounting holes 27 (that are grommetted in the illustrations) around the circumference, which correspond to mounting holes 30 (also grommetted as illustrated) around the circumference of the bottom 18 of the bucket adjacent the opening. The annular base member 26 is mounted to the bucket body 12 by fasteners, typically nut 31, bolt 32 and washer 33 combinations, which pass through the holes 27 in the flange 28 and the holes 30 in the bottom 18 of the bucket 10. An annular seal 41 is typically provided between the flange 28 and the bottom 18 of the bucket.

The base portion 23 of the tubular extension 20 is connected to the annular base member 26 by a heavy duty watertight zipper 44 that extends completely around the circumference of the tubular extension such that the tubular extension 20 is completely separable from the annular base member 26. Accordingly, the zipper 44 enables the tubular extension 20 to be easily removed from, and reattached to, the annual base member 26, thereby providing an efficient mechanism for replacing a worn out valve body 24 without having to undo the plurality of fasteners (such as the nut, bolt and washer combinations) by which the tubular extensions of the prior art are connected to the bottom of the prior art buckets. The valve body 24 of the tubular extension 20 is the portion that typically experiences most of the wear and tear over time as a result of repeated deployments of the tubular extension (i.e. the flexible dump valve). A flexible zipper cover 45, which may be folded over the zipper, is provided for protecting the zipper from physical damage, and may be folded out of the way to allow access to the zipper.

The term “heavy duty watertight zipper” as used herein shall mean a zipper that (1) is watertight, (2) is capable of having its two halves completely separated from each other so as to enable the valve body 24 to be completely removed from the annular base member 26, and (3) is capable of withstanding the force generated on the zipper by a full bucket of water, which tends to force the two halves of the zipper apart to cause separation. Accordingly, whether a zipper that meets criteria (1) and (2) falls within the definition of the term “heavy duty watertight zipper” as used in this specification will be dependent on the particular bucket for which it is used, in particular it will be dependent on the head height of the water in a particular bucket (when full) and the diameter of tubular extension on which the zipper is mounted. At a minimum, for every 1 foot of head height of water and 1 foot of zipper diameter (as defined by the zipper on the annular member), the zipper should withstand 3.2 pounds per lineal inch (“PLI”) of force in order for it to be considered a heavy duty watertight zipper herein. Preferably, the zipper 44 is one that exceeds the minimum threshold by an acceptable safety margin. For example, a heavy duty watertight zipper that is capable of withstanding a force of at least 15 PLI without resulting in separation between the two halves of the zipper encompasses a wide safety margin (a factor of safety of more than five in this example) and would be more than suitable for use in fire fighting buckets in the 72 to 210 U.S. gallon (“USG”) range. Similarly, a heavy duty watertight zipper that is capable of withstanding a force of at least 20 PLI without resulting in separation between the two halves of the zipper encompasses a wide safety margin (a factor of safety of more than five in this example) and would be more than suitable for use in fire fighting buckets in the 240 to 530 USG range. Likewise, a heavy duty watertight zipper that is capable of withstanding a force of at least 45 PLI without resulting in separation between the two halves of the zipper encompasses a wide safety margin (a factor of safety of more than five in this example) and would be more than suitable for use in fire fighting buckets in the 530 to 9800 USG range.

A suitable heavy duty watertight zipper that is suitable for use in fire fighting buckets up to and in excess of 9800 USG was produced and distributed in 2010 under the trademark RIRI EXTREME by Riri SA of Switzerland and/or its affiliates. Other watertight zippers that meet the above mentioned criteria for a heavy duty watertight zipper for a particular size of fire fighting bucket may also be suitable for use in the present invention as zipper 44 for such sized bucket.

While the above description and illustrations constitute preferred or alternate embodiments of the present invention, it will be appreciated that numerous variations may be made without departing from the scope of the invention. It is intended that the invention be construed as including all such modifications and alterations.

What is claimed is:

1. A collapsible fire fighting bucket for being suspended from a helicopter, the fire fighting bucket comprising:
an open bucket body of pliable material having an open upper rim to facilitate filling from a body of water, a side wall extending downwardly from the rim and a bottom cooperating with the side wall and having an opening;
an annular base member of pliable material that is attached to the bottom adjacent to the opening;
a tubular extension made of pliable material and having a base portion at one end and a free end at the other end, wherein the free end defines a discharge port such that the tubular extension functions as a dump valve, the discharge port being sealable for reducing water leakage from the tubular extension;
a heavy duty watertight zipper releasably connecting the base portion of the tubular extension to the annular base member on the bucket body;
suspension means that enables the bucket to be suspended from the helicopter; and
control means on the tubular extension adjacent the discharge port by which movement of the tubular extension may be controlled from the helicopter in a manner that enables the tubular extension to be held in a raised position in which the free end thereof extends upwardly from the bottom with the discharge port positioned below a full water level in the bucket, and to be released and allowed to extend downwardly from the bottom of the bucket for dumping the water.

2. A fire fighting bucket as claimed in claim 1, wherein the heavy duty watertight zipper is of the kind produced or distributed in 2010 under the trademark RIRI EXTREME by Riri SA of Switzerland/or its affiliates.

3. A fire fighting bucket as claimed in claim 1, wherein the heavy duty watertight zipper is capable of withstanding a force of at least 15 pounds per lineal inch without resulting in separation between the two halves of the zipper.

4. A fire fighting bucket as claimed in claim 1, wherein the heavy duty watertight zipper is capable of withstanding a force of at least 20 pounds per lineal inch without resulting in separation between the two halves of the zipper.

5. A fire fighting bucket as claimed in claim 1, wherein the heavy duty watertight zipper is capable of withstanding a force of at least 45 pounds per lineal inch without resulting in separation between the two halves of the zipper.

6. A fire fighting bucket as claimed in claim 1, wherein the heavy duty watertight zipper is capable of withstanding a force of at least 3.2 pounds per lineal inch for every 1 foot of head height of water capacity of the bucket and 1 foot of zipper diameter defined by the zipper on the annular member.
